(19) United States
(12) Patent Application Publication
(10) Pub. No.: US 2007/0070443 A1
(43) Pub. Date: Mar. 29, 2007

(54) Host device having extraction function of text and extraction method thereof

(75) Inventor: Gyong-ock Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/491,921

(22) Filed: Jul. 25, 2006

(30) Foreign Application Priority Data
Sep. 16, 2005 (KR) 2005-86785

(51) Int. Cl. H04N 1/40

(52) U.S. Cl. 358/462; 358/1.13

(57) ABSTRACT

A host device with a text extraction function and a method of extracting a text thereof. The host device having at least one application program with a text extraction function and to execute a certain document, the application program including a user interface part to input a selection signal to select an operation to be executed on an image included in the executed document, a text extraction part to extract a text from the image, and a text process part to execute the selected operation for the extracted text. Therefore, a user can obtain all the text included in the document.

### CROSS-REFERENCE TO RELATED APPLICATIONS

This application claims the benefit under 35 U.S.C. § 119 (a) of Korean Patent Application No. 2005-86785, filed on Sep. 16, 2005, the entire content of which is incorporated herein by reference.

### BACKGROUND OF THE INVENTION

1. Field of the Invention

The present general inventive concept relates to a host device having an extraction function of text and an extraction method thereof. More particularly, the present general inventive concept relates to a host device having a text extraction function capable of performing a certain operation or job on text in an image, and an extraction method thereof.

2. Description of the Related Art

Generally, as more communication techniques develop and personal computers gain popularity, a population that uses the Internet has significantly increased. Additionally, an age group that uses the Internet has expanded from a low age group and to a high age group so that the population using the Internet has continued to increase.

A large amount of information exists on the Internet, and the Internet can be connected to web sites of around the world so that various information can be exchanged and globalization of information may be performed through the Internet.

An Internet user can obtain desired information through the Internet. The Internet user can also download or copy the obtained information to edit the downloaded information as desired.

The information on the Internet includes images as well as text, and the images may include an imaged text. The imaged text can not be copied, stored, and printed independent of the image of which it is a part.

Accordingly, if the text included in an image is desired, a user should manually input the desired text. Therefore, if a large amount of text is included in the image, unnecessary time and efforts are required to use the text.

### SUMMARY OF THE INVENTION

Accordingly, the present general inventive concept provides a host device to extract text in images by using an application program so that a user can perform operations on the extracted text, and a method on extracting text thereof.

Additional aspects of the present general inventive concept will be set forth in part in the description which follows and, in part, will be obvious from the description, or may be learned by practice of the general inventive concept.

The foregoing and/or other aspects and advantages of the present general inventive concept may be achieved by providing a host device having at least one application program with a text extraction function and to execute a certain document, the at least one application program including a user interface part to input a selection signal to select an operation to be executed on an image included in the executed document, a text extraction part to extract a text from the image, and a text process part to execute the selected operation on the extracted text.

The user interface part may receive a second selection signal to select the image, from which the text is extracted, and the text extraction part may extract the text from the selected image.

The text extraction part may extract the text by using a difference of colors in the image. The text extraction part may be an optical character recognition engine (OCR).

The selected operation to be executed on the text may be at least one of a storing operation, a printing operation, a copying operation and a translating operation. If the translating operation is executed, the text process part may provide a translation program to translate the extracted text.

The user interface part may provide a menu on which selectable operations are displayed to enable a user to select the operation to be executed on the text.

The application program may be one of a web browser, a translation program, and a documentor program.

The foregoing and/or other aspects of the present general inventive concept may also be achieved by providing an application program executable on an image forming system, the program including a text extraction part to convert a text item that is part of an image of an image format to a text format, and a process part to enable one or more operations to be performed on the converted text item in the text format.

The foregoing and/or other aspects of the present general inventive concept may also be achieved by providing a user interface unit usable in an application program having a text extractor that extracts imaged text from an image, the user interface unit including an image display portion to display the image having the imaged text therein, and a menu portion adjacent to the image display portion to display one or more selectable operations that are executable on the extracted text when selected.

The foregoing and/or other aspects of the present general inventive concept may also be achieved by providing a method of extracting a text, the method including executing a certain document, extracting a text from an image included in the executed document, and executing a selected operation on the extracted text.

The method may further comprise receiving a first selection signal to select the image from which the text is extracted, wherein the extracting of the text may include extracting the text from the image that corresponds to the input first selection signal of the selected image.

The method may further include receiving a second selection signal of the selected operation for the image, wherein the executing of the selected operation includes executing the selected operation that corresponds to the second selection signal of the operation on the extracted text.

The extracting of the text may include extracting the text by using a difference of colors in the image. The extracting of the text may include extracting the text by using an optical character recognition (OCR) engine.

The operation to be executed on the text may be at least one of a storing operation, a printing operation, a copying operation, and a translating operation.

The foregoing and/or other aspects of the present general inventive concept may also be achieved by providing a computer readable medium containing executable code to extract a text, the medium including an executable code to execute a certain document, an executable code to extract a text from an image included in the executed document, and an executable code to execute a selected operation on the extracted text.

The foregoing and/or other aspects of the present general inventive concept may also be achieved by providing an image forming apparatus network, the network including a host device having an application program running thereon to extract text that is part of an image to a text format, and an image forming apparatus in communication with the host device to receive print data associated with the extracted text in the text format and to print the extracted text.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating a host device having a function of text extraction according to an embodiment of the present general inventive concept;

FIG. 2 is a view illustrating functions of an application program of FIG. 1; and

FIG. 3 is a flowchart illustrating a method of extracting text according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. In the following description, detailed descriptions of functions and configurations that should be known to those of skill in the art have been omitted for conciseness and clarity.

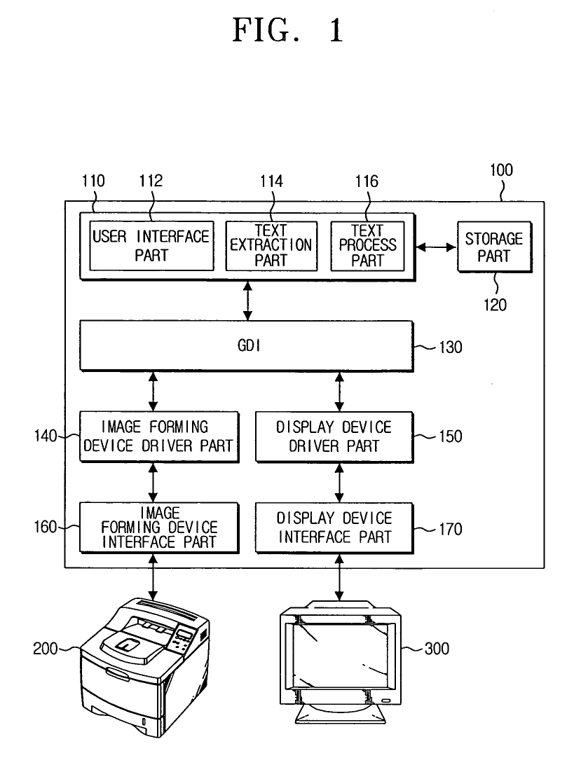

FIG. 1 is a block diagram illustrating a host device 100 having a function of text extraction according to an embodiment of the present general inventive concept.

Referring to FIG. 1, the host device 100 with the text extraction function according to an embodiment of the present general inventive concept includes an application program 110, a storage part 120, a graphic device interface (GDI) 130, an image forming device driver part 140, a display device driver part 150, an image forming device interface part 160, and a display device interface part 170.

The application program 110, which is a general application program installed in the host device 100, generates a new document according to an operation by a user or executes the document selected by the user. In other words, the application program 110 may be operated by one or more user inputs to create, edit, or view various types of documents and files.

The application program 110 may be one of a web browser, a translation program, and a documentor program. If the application program 110 is the web browser, the application program 110 executes a web page of a web site to which the user connects and provides the user with the web page. The translation program may translate the extracted text from one language (e.g., Korean) to another (e.g., English).

The application program 110 extracts a text from an image in the document and performs certain operations on the extracted text. To this end, the application program 110 includes a user interface part 112, a text extraction part 114, and a text process part 116. In other words, text that appears as part of an image (i.e., imaged text) can be extracted into a non-image format. The application program 110 may recognize the imaged text as letters from the image. For example, the image text in a *.JPEG image (or other image formats) can be extracted by the application program 110 and provided as ASCII code. Thus, instead of being provided as image data which typically requires more information to represent the imaged text, the extracted text can be represented using bit combinations used for ASCII characters.

The user interface part 112 provides an interface between the user and the host device 100. In the present embodiment, the user interface part 112 inputs a first selection signal indicating the image, from which the text is to be extracted, and a second selection signal(s) indicating the operation to be performed on the text extracted from the selected image.

The user interface part 112 provides a menu on which the selectable operations (i.e., jobs) are displayed so that the user can select the operation (i.e., job) to perform on the text. The menu provided by the user interface part 112 may include “store the text included in the image” (i.e., a store text function), “print the text included in the image” (i.e., a print text function), “copy the text included in the image” (i.e., a copy text function), and “translate the text included in the image” (i.e., a translate text function).

If the first selection signal of the image is input through the user interface part 112 by the user, the text extraction part 114 extracts the text from the image that corresponds to the input first selection signal of the image.

The text extraction part 114 may include an image processing module that extracts the text included in the image. The image processing module can extract the text by using a difference of colors in the image.

The text extraction part 114 may be an optical character recognition (OCR) engine. The OCR engine divides the image or bitmap into bright portions and dark portions to analyze the bright and dark portions. If a text character is sensed, the text extraction part 114 can extract the text by converting the text into ASCII code.

The text process part 116 executes operations (i.e., jobs) that correspond to the second selection signal(s) for the operations to perform on the text extracted by the text extraction part 114. The second selection signal(s) of the operations are input through the user interface part 112. The operations, which are executed on the text by the text process part 116, includes storing, printing, copying, and translating, which correspond to the menu provided by the user interface part 112 that displays various functions from which the user may select.

If a storing operation is executed, the text process part 116 controls the storage part 120 to store the data extracted by the text extraction part 114.

If a printing operation is executed, the text process part 116 provides the data extracted by the text extraction part 114 through the GDI 130 to the image forming device driver part 140.

If a copying operation is executed, the text process part 116 controls the storage part 120 to temporarily store the data extracted by the text extraction part 114. The text may be stored to a clipboard depending on the application program 110.

If a translating operation is executed, the text process part 116 transmits the data extracted by the text extraction part 114 to a translation program. At this time, the application program 110 may be the web browser or the documentor program, and the translation program is a program that exists in or is running on the host device 100.

The storage part 120 stores certain documents. The certain documents may be produced by the application program 110. If the application program 110 is the web browser, downloaded images may be temporarily stored to the storage part 120. The images are downloaded from the web site to which the user connects to extract text from the web site. Additionally, if the storing operation is to be executed by the text process part 116, the storage part 120 may store the text under the control of the text process part 116.

The GDI 130, which is a type of operating system (e.g., Microsoft Windows), provides an interface between the application program 110 and the image forming device driver part 140, or the application program 110 and the display device driver part 150.

In other words, the GDI 130 transmits a printing command and print data transmitted from the application program 110 to the image forming device driver part 140, and transmits display data from the application program 110 to the display device driver part 150.

The image forming device driver part 140 converts the printing command and the print data transmitted through the GDI 130 from the application program 110 into a data form readable in the image forming device 200.

The display device driver part 150 converts the display data transmitted through the GDI 130 from the application program 110 into a data form readable in the display device 300. The display data may include the document executed by the application program 110 and the menu provided by the user interface part 112.

The image forming device interface part 160 provides an interface between the host device 100 and the image forming device 200, and transmits the data that is converted into the data form readable in the image forming device 200 by the image forming device driver part 140 to the image forming device 200.

The display device interface part 170 provides an interface between the host device 100 and the display device 300, transmits the data that is converted into the data form readable in the display device 300 by the display device driver part 150 to the display device 300.

The image forming device 200 executes a printing job (operation) for the print data received through the image forming device interface part 160 from the host device 100. In the present embodiment, the image forming device 200 executes the printing job if the operation executed by the text process part 116 is the printing operation.

The display device 300 displays the display data transmitted through the display device interface part 170 from the host device 100. In the present embodiment, the display data displayed on the display device 300 includes the document executed (i.e., accessed) by the application program 110.

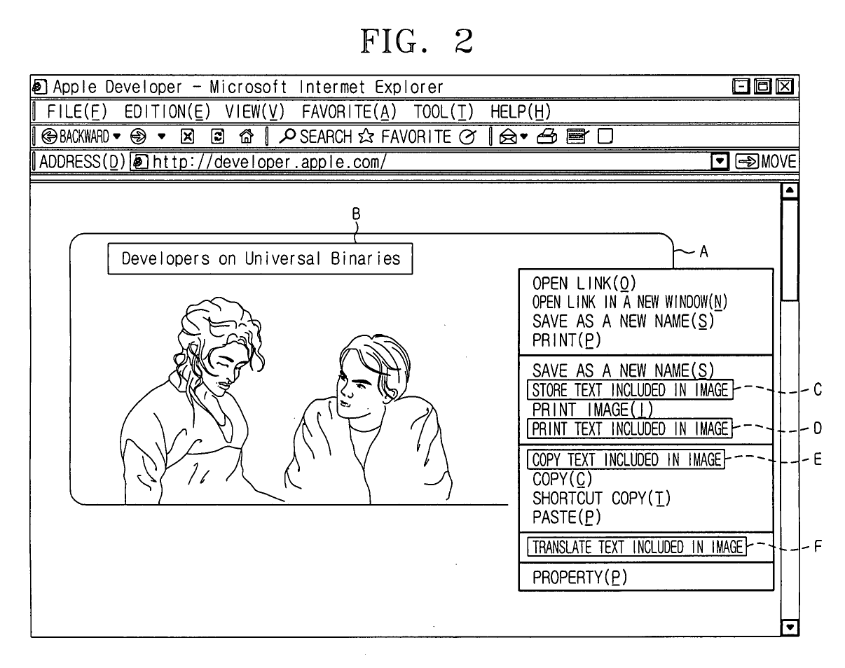

FIG. 2 is a view illustrating functions of the application program 110 of FIG. 1.

Referring to FIGS. 1 and 2, the functions of application program 110 will be explained when the application program 110 is assumed to be the web browser. The user connects to a certain web site through the web browser, and the web browser executes the document provided from the web site to provide the user with the document (i.e., contents thereof). Therefore, the user can execute the operations such as the copying operation, the storing operation, the printing operation, and the translating operation for the document provided from the web browser.

As illustrated in FIG. 2, the document provided to the user includes a text and image A, and the image A may include an imaged text B. The imaged text B included in the image A is comprehended in the same manner as the image A, and therefore, the user can not use conventional methods to obtain the imaged text B independent of the image A. In other words, the imaged text B is part of a file of the image A.

According to an embodiment of the present general inventive concept, the user interface part 112 of the application program 110 provides the menu for selecting operations for the imaged text B, such as the “store the text included in the image” C (i.e., the store text function), the “print the text included in the image” D (i.e., the print text function), and the “copy the text included in the image” E (i.e., the copy text function), and the “translate the text included in the image” F (i.e., the translate text function). The user interface part 112 may also include one or more other general menus.

If the user selects the image A from which to extract the text, the user interface part 112 provides the user with the menu for selecting desired operations including the menu for selecting the operation for the imaged text B. Therefore, the user can select one of the operations such as the storing operation, the printing operation, the copying operation, and the translating operation for the imaged text B included in the image A.

The user selects the job for the imaged text B to obtain the imaged text B included in the image A by the text extraction part 114 and the text process part 116 of the application program 110.

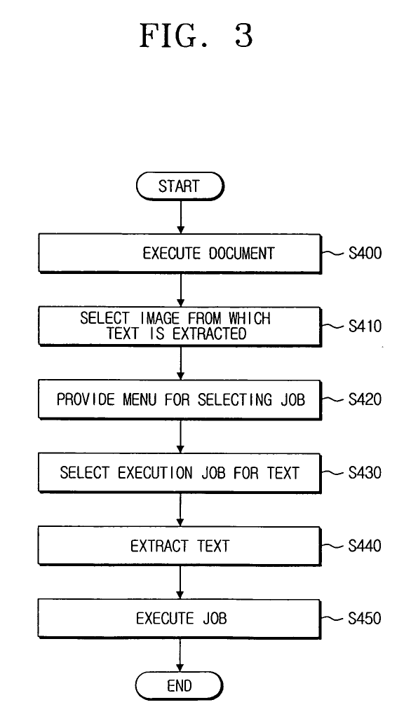

FIG. 3 is a flowchart illustrating a method of extracting text according to an embodiment of the present general inventive concept. The method of FIG. 3 may be performed by the host device 100 of FIG. 1. Accordingly, for illustration purposes, the method of extracting text according to the present embodiment will be explained with reference to FIGS. 1 through 3.

The application program 110 executes the document selected by the user. For example, if the application program 110 is the web browser, the web browser connects to the web site of a web site address input by the user and executes the document provided by the web site (operation S400).

If the user wishes to use only the imaged text B from among the image A included in the document provided from the application program 110, the user selects the image A from which the text is extracted (operation S410).

If the user selects the image A from which the text is extracted, the application program 110 provides the menu C, D, E, and F for selecting operations for the imaged text B through the user interface part 112 (operation S420). For example, the menu may be displayed in response to selection of the image A.

If the menu C, D, E, and F as illustrated in FIG. 2 is provided, the user can select the desired operation for the imaged text B. When the user selects the desired operation for the image A, from which the text is extracted, and the imaged text B, the first and second selection signals of the image and operation (i.e., job) are input through the user interface part 112 into the application program 110 (operation S430).

The text extraction part 114 of the application program 110 extracts the text from the image A (operation S440). If the text is extracted from the image A by the text extraction part 114, the text process part 116 executes the operations that correspond to the second selection signal(s) of the operation selected by the user (operation S450).

The method of extracting text has been explained when the application program 110 is a web browser. However, this should not be considered as limiting the scope of the present general inventive concept. The application program 110 may be other document creating/editing/viewing programs such as a general documentor program or a translation program.

If the application program 110 is the translation program, the text extraction part 114 of the application program 110 extracts the imaged text B, and the text process part 116 allows a translation module to translate the extracted text so that all the text included in the document can be translated.

Additionally, the application program 110 may be the translation program that is plugged into the web browser to be executed. The translation program may be executed with a document that is opened through the web browser, or the translation program may be executed and then the document is opened through the web browser.

That is, the application program 110 according to an embodiment of the present general inventive concept may be applied to various programs such as the web browser, the documentor program, and the translation program, and can execute operations such as editing and translating for the text included in the document according to an input of the user. Alternatively, the application program 110 may be pre-set to perform one or more of the operations automatically. For example, the web browser may be preset to extract the text in selected images and automatically save a copy of the extracted text and/or automatically translate a copy of the extracted text to another language.

The embodiments of the present general inventive concept can be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software.

A host device with a text extraction function and a method of extracting text according to embodiments of the present general inventive concept extract the text included in an image by an application program and execute certain operations so that a user can obtain all the text included in the document. Additionally, the host device extracts the text from the image and provides the user with the extracted text so that a consumption of ink that results from printing of unnecessary images can be decreased. Therefore, a printing speed can also increase.

While the general inventive concept has been shown and described with reference to certain embodiments thereof, it will be understood by those skilled in the art that various changes in form and details may be made therein without departing from the spirit and scope of the general inventive concept as defined by the appended claims.

What is claimed is:

1. A host device having at least one application program with a text extraction function to execute a certain document, the at least one application program comprising:
a user interface part to input a selection signal to select an operation to be executed on an image included in the executed document;
a text extraction part to extract a text from the image; and
a text process part to execute the selected operation on the extracted text.

2. The device as claimed in claim 1, wherein the user interface part receives a second selection signal to select the image, from which the text is extracted, and
the text extraction part extracts the text from the selected image.

3. The device as claimed in claim 1, wherein the text extraction part extracts the text by using a difference of colors in the image.

4. The device as claimed in claim 1, the text extraction part is an optical character recognition engine (OCR).

5. The device as claimed in claim 1, wherein the selected operation to be executed on the text is at least one of a storing operation, a printing operation, a copying operation, and a translating operation.

6. The device as claimed in claim 5, wherein if the translating operation is executed, the text process part provides a translation program to translate the extracted text.

7. The device as claimed in claim 1, wherein the user interface part provides a menu on which selectable operations are displayed to enable a user to select the operation to be executed on the extracted text.

8. The device as claimed in claim 1, wherein the application program is one of a web browser, a translation program, and a documentor program.

9. An application program executable on an image forming system, the program comprising:
a text extraction part to convert a text item that is part of an image of an image format to a text format; and
a process part to enable one or more operations to be performed on the converted text item in the text format.

10. The program as claimed in claim 9, wherein the text format comprises ASCII code.

11. The program as claimed in claim 9, wherein the text item as the image format is substantially larger than the converted text item as the text format.

12. The program as claimed in claim 9, wherein the text extraction part receives the text item from a web page.

13. The program as claimed in claim 9, wherein the process part comprises a translation program to translate the converted text item in the text format from a first language to a second language.

14. The program as claimed in claim 9, wherein the text extraction part comprises an OCR engine to divide the image into bright portions and dark portions to analyze the bright and dark portions.

15. The program as claimed in claim 9, further comprising:
a user interface part to receive a first selection signal to select the image from which the text item is converted to the text format from among a plurality of images and a second selection signal to indicate the one or more operations to be performed on the converted text item.

16. The program as claimed in claim 9, wherein the one or more operations comprise
a store text operation to store the converted text item locally in the host device without the image;
a copy text operation to copy the converted text item without the image; and
a print text operation to print the converted text item without the image;
a translate text operation to translate the converted text item.

17. The program as claimed in claim 9, wherein the process part is set to perform the one or more operations on the converted text item automatically.

18. A method of extracting a text, the method comprising:
executing a certain document;
extracting a text from an image included in the executed document; and
executing a selected operation on the extracted text.

19. The method as claimed in claim 18, further comprising:
receiving a first selection signal to select the image from which the text is extracted,
wherein the extracting of the text comprises extracting the text from the image that corresponds to the input first selection signal of the selected image.

20. The method as claimed in claim 18, further comprising:
receiving a second selection signal of the selected operation for the image,
wherein the executing of the selected operation comprises executing the selected operation that corresponds to the second selection signal of the operation for the extracted text.

21. The method as claimed in claim 18, wherein the extracting of the text comprises extracting the text by using a difference of colors in the image.

22. The method as claimed in claim 18, wherein the extracting of the text comprises extracting the text by using an optical character recognition (OCR) engine.

23. The method as claimed in claim 18, wherein the operation to be executed on the text is at least one of a storing operation, a printing operation, a copying operation, and a translating operation.

24. A computer readable medium containing executable code to extract a text, the medium comprising:
an executable code to execute a certain document;
an executable code to extract a text from an image included in the executed document; and
an executable code to execute a selected operation on the extracted text.

25. An image forming system network, the network comprising:
a host device having an application program running thereon to extract text that is part of an image to a text format; and
an image forming apparatus in communication with the host device to receive print data that corresponds to the extracted text in the text format and to print the extracted text.
